(19) United States
(12) Patent Application Publication
(10) Pub. No.: US 2020/0390656 A1
(43) Pub. Date: Dec. 17, 2020

(54) APPARATUS FOR DISPENSING PILLS

(71) Applicant: Patch Technologies, Inc., San Antonio, TX (US)

(72) Inventors: Andrew Aertker, San Antonio, TX (US); Gavin Buchanan, San Antonio, TX (US)

(21) Appl. No.: 16/442,452

(22) Filed: Jun. 15, 2019

(51) Int. Cl. A61J 7/04; A61J 1/03; B65D 50/00

(52) U.S. Cl. CPC A61J 7/0418; A61J 1/03; B65D 2215/00; B65D 2203/12; B65D 50/00

(57) ABSTRACT

A system and method for dispensing a pill. A pill bottle may be coupled with a pill dispensing bottle cap. The pill dispensing bottle cap may comprise a closure system for the pill dispensing bottle cap to the pill bottle. The pill dispensing bottle cap may comprise an interior funnel, an interior pathway, an exterior pathway, an exterior opening, a delivery system, an activation system, and a sensor. The interior funnel may navigate one or more pills towards the interior pathway. The activation system may determine if activation of the delivery system is appropriate. The delivery system may cause a pill to move from the interior pathway to the exterior pathway. The pill may move from the exterior pathway through the exterior opening and exit the pill bottle. The sensor may detect the pill exiting the pill bottle and cause pill information associated with the pill bottle to be updated.

### CROSS-REFERENCE TO RELATED APPLICATIONS

None

### BACKGROUND

### Field of the Art

This invention generally relates to an apparatus for dispensing medical pills. More specifically, the invention relates to a bottle cap that attaches to pill bottles and dispenses pills that are stored in the bottle in accordance to a dosing schedule.

### Discussion of the State of the Art

Prior art systems and methods for automatically dispensing pills according to a dosing schedule require complex—and often expensive—equipment. For example, pill dispensing systems typically require specialized equipment and specialized software to dispense pills. However, most clinicians and patients do not have the budgets to purchase expensive, specialized equipment necessary to use these systems. Indeed, because of these and other constraints, the adoption and usage rate for these types of systems is abysmally low.

Moreover, prior art systems for automatically dispensing pills are designed to prevent users and others from opening the various devices in an effort to prevent theft, overdosing, medication loss, and prescription noncompliance. As a result, because of the lack of accessibility, these systems typically require regulatory approval for use and deployment. This regulatory compliance adds another significant layer and barrier to widespread market adoption of automatic pill dispensing systems.

What is needed is a low-cost method for allowing clinicians and users to receive dispensed medication at a dosing schedule without significantly impairing the user's ability to access the pills.

### SUMMARY

The inventive apparatus disclosed herein represents a low-cost solution for dispensing medicine or pills in accordance with a dosing schedule. In one embodiment of the invention, the inventive apparatus is as a bottle cap that couples to traditional prescription bottles of various shapes and sizes. Generally, the inventive apparatus permits a pill to exit the bottle even when the bottle cap is securely coupled to a bottle in a closed configuration. This is accomplished via offset interior pathways that extend from one end of the bottle cap to another. The offset interior pathways typically remain unconnected, thereby preventing a pill from exiting through the inventive bottle cap. However, when a user activates a connection portion, the two interior pathways become connected and enable a pill to travel through the interior pathways and exit the bottle. In one embodiment, the connection portion may only be activated in accordance with a dosing schedule. As such, the inventive apparatus permits users and clinicians to dispense pills in accordance to a dosing schedule.

The inventive apparatus may also be removed or de-coupled from a bottle if a user wants to open the bottle or over-ride the dispensing system. For example, the inventive apparatus may include traditional threads that allow a user to screw the bottle top on and off as desired. The bottle cap of the present invention may also include traditional safety or child-safety locking mechanisms that are known in the art. This feature of the invention makes it safer to use the bottle cap (by preventing children and others from being able to uncouple the bottle cap from a bottle), and does not require the user to learn a new method for opening or closing a bottle with a bottle cap. Moreover, the apparatus does not require additional regulatory approvals to deploy and use.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates an exemplary bottle cap for dispensing pills, in accordance with one embodiment of the invention.

FIG. 2 illustrates an exemplary bottle cap for dispensing pills, in accordance with one embodiment of the invention.

FIG. 3 illustrates, from a top view, an exemplary bottle cap in accordance with one embodiment of the invention.

FIG. 4 illustrates, from a bottom view, an exemplary bottle cap in accordance with one embodiment of the invention.

FIG. 5 illustrates, in a cross-sectional view, an exemplary bottle cap in accordance with one embodiment of the invention.

FIG. 6 illustrates a block diagram illustrating an exemplary system for using the inventive apparatus in accordance with an embodiment of the invention.

FIG. 7 illustrates a block diagram illustrating an exemplary system disposed in the inventive apparatus in accordance with an embodiment of the invention.

FIG. 8 illustrates a process diagram illustrating an exemplary method in accordance with an embodiment of the invention.

FIG. 9 illustrates a block diagram of an exemplary hardware architecture of a computing device, according to a preferred embodiment of the invention.

FIG. 10 illustrates a block diagram of an exemplary logical architecture for a client device, according to a preferred embodiment of the invention.

FIG. 11 illustrates a block diagram showing an exemplary architectural arrangement of clients, servers, and external services, according to a preferred embodiment of the invention.

FIG. 12 is another block diagram illustrating an exemplary hardware architecture of a computing device, according to a preferred embodiment of the invention.

### DETAILED DESCRIPTION

The inventor has conceived, and reduced to practice, an apparatus, a system, and a method for dispensing pills in accordance to a dosing schedule. Various embodiments of the inventive apparatus, system, and method are disclosed herein, including numerous alternative arrangements. However, it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Conceptual Architecture

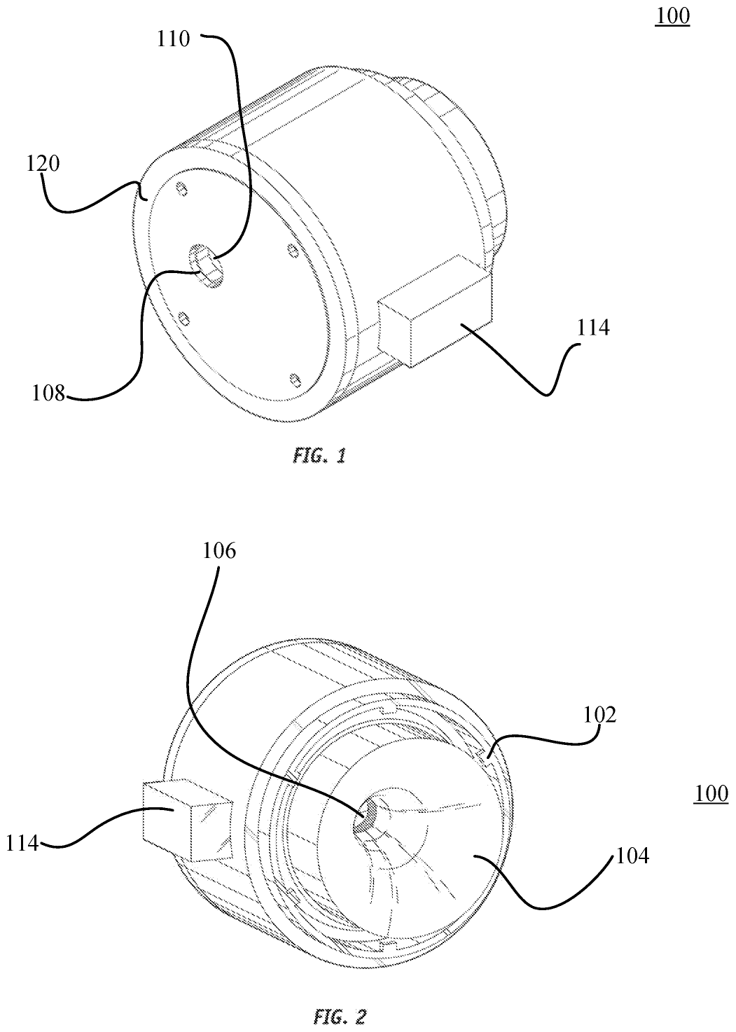

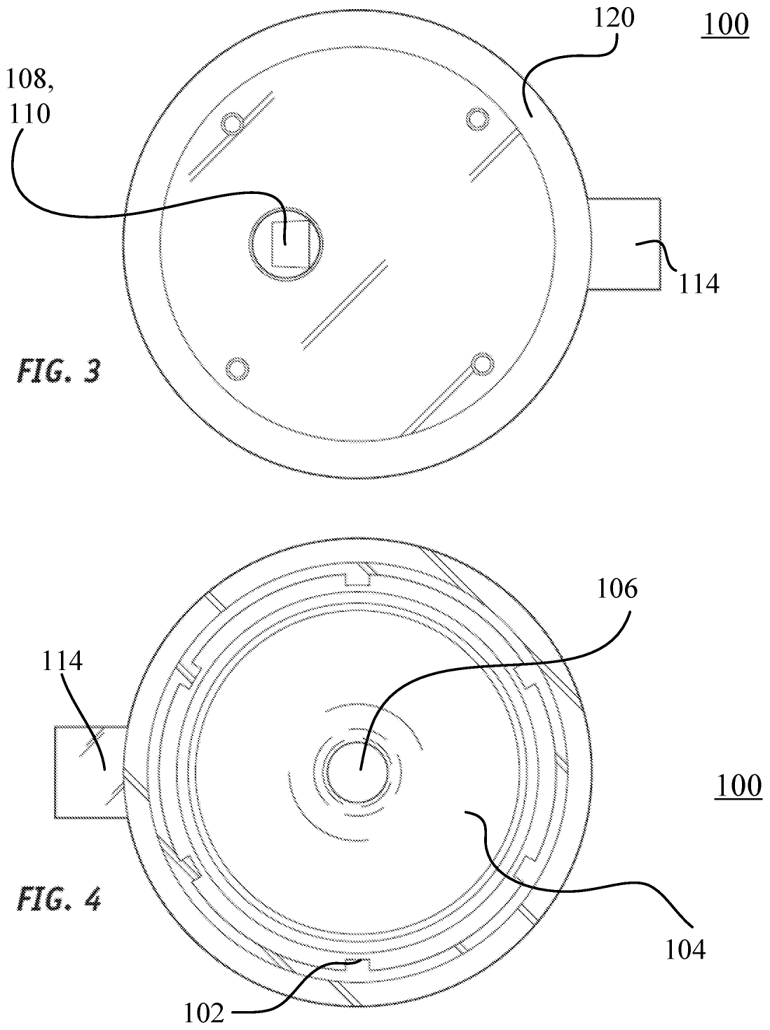

FIGS. 1-5 illustrate a pill dispensing bottle cap in accordance with one embodiment of the invention. As shown in FIGS. 1-5, the pill dispensing bottle cap 100 is comprised of a closure system 102, an interior funnel 104, an interior pathway 106, an exterior opening 108, an exterior pathway 110, a delivery system 112, an activation system 114, a pill sensor 116, an opening sensor 118, and a light source 120.

The elements enable a user to remove a pill from a bottle without opening the bottle i.e. the elements described herein enable a pill to travel through the pill dispensing bottle cap 100, and do not require a user to unscrew or remove the bottle cap 100 to dispense a pill. For example, in one exemplary method for dispensing a pill, a user may partially or fully invert a bottle that is closed with the pill dispensing bottle cap 100, which causes one or more pills to travel, via the force of gravity, towards the interior funnel 104. The interior funnel 104 may direct at least one pill to travel through the interior pathway 106 until the at least one pill reaches the delivery system 112. The delivery system 112—upon activation of the activation system 114 by the user—causes the at least one pill to move from the interior pathway 106 to the exterior pathway 110. Thereafter, the at least one pill may exit the bottle cap 100 through the exterior opening 108 via the force of gravity.

In one embodiment of the invention, the pill dispensing bottle cap 100 may comprise electronic components that communicate with an electronic device to dispense pills in accordance with a dosing schedule. For example, an electronic communication device may communicate with an electronic device to determine if it is time for a user to take a pill in accordance with a dosing schedule. If it is appropriate to take a pill, then the light source 120 may illuminate in green or an appropriate color. If it is appropriate to take a pill, then the light source 120 may illuminate in red or an appropriate color. In one embodiment, the light source 120 may continuously emit light, emitting one appropriate color when it is appropriate to take a pill and emitting another appropriate color when it is not appropriate to take a pill. In one embodiment, the light source 120 may emit light in response to activation of the activation system 114. In one embodiment of the invention, the activation system 114 may be disabled or may be rendered inoperable when it is determined that, according to the dosing schedule, it not appropriate to take a pill. Conversely, in accordance with an embodiment of the invention, the activation system 114 may be disabled by default, but when, according to a dosage schedule, it is appropriate to dispense a pill, the activation system 114 may become enabled. In one embodiment of the invention, the pill sensor 116 may record each instance of when a pill has exited the pill dispensing bottle cap 100. The recorded information may be sent to another computing device to monitor compliance and update the dosing schedule. In one embodiment of the invention, the opening sensor 118 may record instances of when the bottle cap is removed from the bottle. Once an opening is recorded, the dosing schedule may be disregarded because the pill dispensing bottle cap 100 may not be able to determine how many pills were added or removed while opened. The recorded instances of opening may be transmitted to a computing device via the communication device.

### DETAILED DESCRIPTION OF EXEMPLARY EMBODIMENTS

Referring now to FIGS. 1-5, which illustrate the various exemplary embodiments of the invention, including a closure system 102, an interior funnel 104, an interior pathway 106, an exterior opening 108, an exterior pathway 110, a delivery system 112, an activation system 114, a pill sensor 116, an opening sensor 118, and a light source 120.

The closure system 102 may enable the pill dispensing bottle cap 100 to be affixed (e.g., attached, fastened, stuck, etc.) to a pill bottle (e.g., pill container, etc.). The closure system 102 may enable a user to securely store pills until a pill is ready for use in accordance with a dosing schedule. The closure system 102 may comprise a traditional safety locking mechanism. The closure system 102 may comprise a child safety-locking mechanism. In one embodiment, the closure system 102 may comprise the opening sensor 118. The opening sensor 118 may detect a separation of the closure system 102 or the bottle cap 100 from the pill bottle. A variety of different mechanisms for detecting the removal may be used without departing from the scope of the invention. For example, contact pins that detect contact between the bottle cap 100 or the closure system 102 and the bottle may be used in one embodiment. In other embodiments, the opening sensor 118 may also comprise one or more accelerometers. In one embodiment, the closure system 102 may comprise a portion of the opening sensor 118. The opening sensor 118 may transmit a signal indicative of the separation of the closure system 102 from the pill bottle to a computing device. The pill dispensing bottle cap 100 may comprise the computing device. The computing device may be remote from the pill dispensing bottle cap 100. The opening sensor 118 may transmit the signal indicative of the separation of the closure system 102 from the pill bottle to a remote computing device via a network. The opening sensor 118 may cause an inventory of pills in a pill bottle in communication with the pill dispensing bottle cap 100 to be considered invalid. The opening sensor 118 may cause a person and/or entity (such as a physician and/or a pharmaceutical company) related to a dosing schedule to be notified.

The interior funnel 104 helps ensure that one or more pills travel from the pill container to an appropriate portion of the bottle cap 100 such that the pill can exit through the bottle cap 100. In one embodiment, the interior funnel 104 may comprise a conic shape. The interior funnel 104 may comprise a first end and a second end. The first end may comprise a first circle comprising a first radius. The first end is closer to the the pill dispensing bottle, as compared to the second end, when the pill dispensing bottle cap 100 is affixed to a pill bottle. The second end may comprise a second circle comprising a second radius. The second end may be adjacent to the interior pathway 106. In one embodiment of the invention, the first radius is greater than the second radius, which, in effect, funnels pills from the interior portion of the pill bottle towards the interior pathway 106, while, at the same time, preventing the pills from accumulating and/or blocking the interior pathway 106. In one embodiment of the invention, the first radius may be a size that allows multiple pills into the interior funnel 104. The second radius may be a size that allows one pill to travel out of the interior funnel 104 and into the interior pathway 106. The interior funnel 104 may gradually narrow from the first end to the second end. The interior funnel 104 may be configured such that, when a pill bottle is turned upside-down, gravitation force will cause at least one pill to travel from the first end to the second end and towards the interior pathway 106.

The interior pathway 106 may comprise an opening to permit one or more pills to travel from the interior funnel 104 to the delivery system 112. Non limiting examples of openings comprising the interior pathway 106 include, but are not limited to, an aperture, a cavity and/or a tunnel through which one or more pills travel. In one embodiment of the invention, the interior pathway 106 may comprise a cylindrical shape. The cylindrical shape may comprise a radius that is the same or similar to the second radius of the interior funnel 104. The interior pathway 106 may be configured to accommodate one pill at a time in a particular orientation. In one embodiment, the interior pathway 106 may cause pills to be arranged in a pill queue which may extend from the interior pathway 106 to the interior funnel 104. In other embodiments, however, the interior pathway 106 may be configured to accommodate several pills, or one or more pills that can travel through the interior pathway 106 in one or more orientations. The interior pathway 106 may hold a pill until the pill is delivered to the exterior pathway 110 upon activation by the user.

Activation of the activation system 114 enables a user to take an action to deliver a pill from the interior pathway 106 to an exterior pathway 110. The activation system 114 may comprise, for example, a button, a switch, a lever, a touch enabled contact surface, etc., wherein a user may initiate a delivery system by interacting with the activation system 114. A variety of interaction systems may be used, including but not limited to, engagement of a control, a press of a button, a flip of a switch, a turn of a knob, engagement of a slide, a voice command, the like, and/or any combination of the foregoing. In one embodiment of the invention, the activation system 114, upon activation by a user, queries a computing device to determine if a user is permitted to take or receive a pill. If the computing device provides that the user is permitted to receive a pill, then the activation system 114 initiates the delivery system 112, in response to the user's input interaction. If the user is not permitted to take or receive a pill at that time, then the activation system 114 may not activate the delivery system 112 and a pill may not be removed via the bottle cap device 100 described herein. In other words, activation of the activation system 114 may comprise receiving a signal from a computing device. The computing device may transmit the signal in response to determining that a pill should be taken in accordance with a dosing schedule.

The delivery system 112 delivers one or more pills within the interior pathway 106 and/or within the delivery system 112 in response to activation of the activation system 114. Delivering the pill may comprise moving the pill from the interior pathway 106 to the exterior pathway 110. On activation of the activation system 114, the delivery system 112 may cause the pill to meet the exterior pathway 110. In one embodiment, the delivery system 112 may cause the interior pathway 106 to connect to the exterior pathway 110. In one embodiment, the delivery system 112 may cause the pill to move to the exterior pathway 110. In one embodiment, the delivery system 112 may cause the interior pathway 106 to move to and connect with the exterior pathway 110 in such a manner that a pill can travel from the interior pathway 106 to the exterior pathway 110. In one embodiment, the delivery system 112 may cause the exterior pathway 110 to move to the pill. In one embodiment, the delivery system 112 may cause the exterior pathway 110 to move to the interior pathway 106. In one embodiment, the delivery system 112 may cause the pill and the exterior pathway 110 to each move towards each other. In one embodiment, the delivery system 112 may cause the interior pathway 106 and the exterior pathway 110 to each move towards each other. Movement of the pill, the interior pathway 106, and/or the exterior pathway 110 caused by the delivery system 112 may, in one embodiment, comprise a rotating movement relative to an axis. In other embodiments, the interior pathway 110 and/or the exterior pathway 110 may slide to enable a pill to travel from the interior pathway 106 to the exterior pathway 110. Movement of the pill, the interior pathway 106, and/or the exterior pathway 110 caused by the delivery system 112 may comprise a lateral movement relative to a plane.

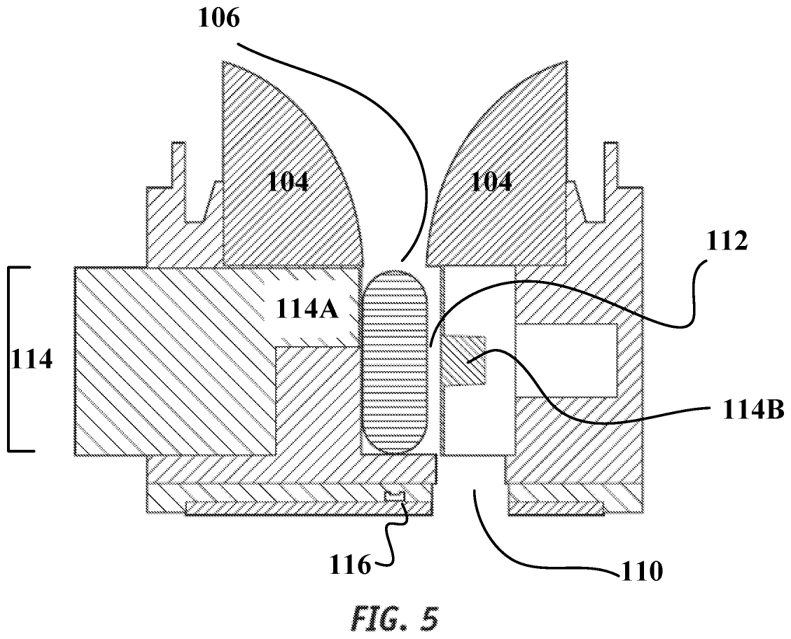

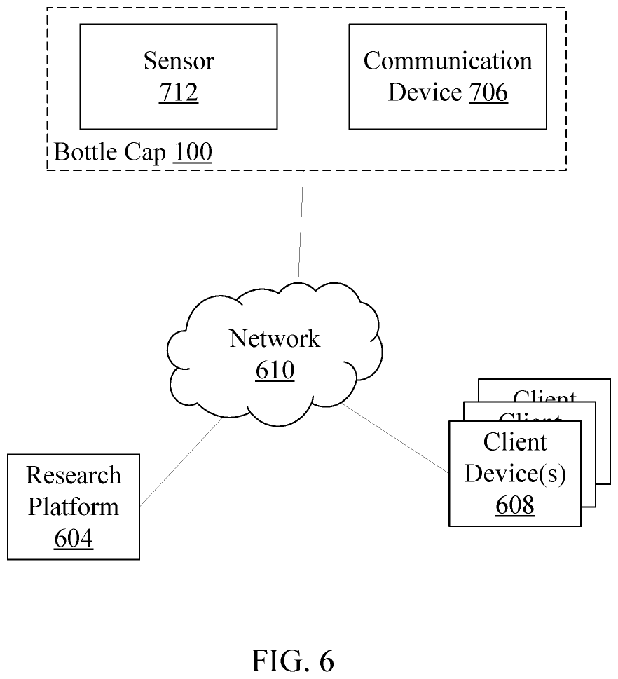

In one exemplary embodiment of the invention, as illustrated in FIG. 5, the delivery system 112 delivers a pill from the interior pathway 106 to the exterior pathway 110. In this particular embodiment, the delivery system 112 is large enough to accommodate one pill in one orientation. However, in other embodiments, more than one pill may be accommodated by the delivery system 112. Upon activation of the activation system 114, for example, from left to right in FIG. 5, the extension portions of the activation system 114A and 114B (sometimes also referred to as the delivery system 112) extend from left to right, thereby causing a pill to travel from one side of the bottle cap to another. For example, in one exemplary embodiment, the delivery system 114A and 114B pushes the pill from the left most portion of the delivery system 112 (which is in alignment with the interior pathway 106) to the right most portion of the delivery system 112 (which is in alignment with the exterior pathway 110). This movement causes the pill to fall into the exterior pathway 110 via the force of gravity and eventually exit the bottle cap 100.

The pill sensor 116, via one of a variety of different sensing mechanisms, determines that a pill has passed the exterior pathway 110 when a pill move from the exterior pathway and sends a signal to a computing device notifying the computing device that a pill has exited the device along with a date and timestamp of when the pill has passed through the exterior pathway 110.

The exterior pathway 110 may comprise a aperture, a cavity and/or a tunnel that is open ended on two sides. In one embodiment of the invention, the exterior pathway 110 may comprise a cylindrical shape. The cylindrical shape may comprise a radius that is the same or similar to the second radius of the interior funnel 104 and/or the interior pathway 106. The exterior pathway 110 may be configured to accommodate one pill at a time. In other embodiments, however, the exterior pathway 110 may be configured to accommodate several pills or one or more pills that can travel through the exterior pathway 110 in one or more orientations. In one embodiment, the exterior pathway 110 may cause pills to be arranged in a pill queue. The exterior pathway 110 may be adjacent to the exterior opening 108. The exterior opening 108 may comprise a hole or an aperture. The exterior opening 108 may comprise a circle. In one embodiment, the circle may comprise a radius that is the same or similar to the radius of the exterior pathway 110. However, other diameters may be used without departing from the scope of the invention. A pill may arrive at the exterior opening 108 via the exterior pathway 110. A pill may exit the pill bottle via the exterior pathway 110. A pill may exit the pill bottle via the exterior pathway 110 because of a force caused by gravity.

The pill sensor 116 may detect a pill when a pill exits the bottle cap 100. In one embodiment, the pill sensor 116 detects when a pill is in contact with the pill sensor 116. In one embodiment, the pill sensor 116 may be comprised throughout the interior pathway 106, the exterior pathway 110, and/or the exterior opening 110 may comprise the pill sensor 116. In one embodiment, the pill sensor 116 may be disposed towards a portion of the exterior pathway. The pill sensor 116 may detect a change in light caused by delivery of a pill. The pill sensor 116 may detect an audio signal caused by delivery of a pill. The pill sensor 116 may detect delivery of a pill by the delivery system 112 to the exterior pathway 110. In one embodiment, the pill sensor 116 meant to take to any combination described herein. In one embodiment, the pill sensor 116 may detect activation of the activation system 114. The pill sensor 116 may transmit a signal indicative of a pill exiting the apparatus 100 to a computing device. In one embodiment, the computing device may be disposed within the pill dispensing bottle cap 100. For example, a counter or an electronic chip may be disposed within the apparatus 100. In another embodiment of the invention, the computing device may be remote from the pill dispensing bottle cap 100. The pill sensor 116 may transmit the signal indicative of the pill consumed to a remote computing device via a network or via a wired transmission system. The pill sensor 116 may cause an inventory of pills in a pill bottle in communication with the pill dispensing bottle cap 100 to be decremented. The pill sensor 116 may cause a dosing schedule to be checked.

The light source 120 may comprise one or more light-emitting diodes (LEDs). The light source 120 may be controlled by a computing device and/or the logic device on the bottle cap 100. The pill dispensing bottle cap 100 may comprise the computing device controlling the light source 120. The computing device controlling the light source 120 may be remote from the pill dispensing bottle cap 100. The light source 120 may react to a signal provided by the computing device. The light source 120 may comprise a setting associated with a time to take a pill. The light source 120 may comprise a setting associated with a time not to take a pill. A setting may comprise a position (e.g., “on”, “off”, etc.), a light pattern (e.g., every LED illuminated, every other LED illuminated, every third LED illuminated, etc.), a flashing pattern (e.g., blinking, two fast flashes followed by a long pause, etc.), a color (e.g., red, green, etc.), the like, and/or any combination of the foregoing. For example, the light source 120 may display a green color in response to a signal indicative of a time to take a pill. As another example, the light source 120 may display a red color in response to a signal indicative of a time not to take a pill. The light source 120 may illuminate in response to a user engaging the activation system 114. The light source 120 may illuminate in response to an accelerometer detecting a movement of the pill dispensing bottle cap 100.

In an example, a pharmaceutical company seeking Food and Drug Administration (FDA) approval for a drug may put the drug in pill bottles for trials, wherein each pill bottles comprises a pill dispensing bottle cap 100. Each pill dispensing bottle cap 100 may be secured to a respective pill bottle using a respective closure system 102. The pharmaceutical company may create a dosing schedule for each trial participant based on factors, such as height, weight, age, gender, etc. Each dosing schedule may be maintained in a server associated with the pharmaceutical company. Each trial participant may receive (e.g., download, access, etc.) a respective dosing schedule from the server at a respective client device, such as a smart phone. Each pill dispensing bottle cap 100 may be in communication with a respective client device using a messaging protocol, such as Wi-Fi or Bluetooth and others. The communication may be direct communication between the respective client device and the respective pill dispensing bottle cap 100, or through an intermediary device, such as a Wi-Fi router. The respective pill dispensing bottle cap 100 may receive an signal indicating if a pill should be dispensed at a current time or not. If a trial participant turns over a respective pill bottle and tries to engage a respective activation system 114 of a respective pill dispensing bottle cap 100 at a time outside of the dosing schedule, a respective light source 120 of the pill dispensing bottle cap 100 may flash a red light and the respective activation system 114 may fail to activate a respective delivery system 112. If the trial participant turns over the respective pill bottle and tries to engage the respective activation system 114 of a respective pill dispensing bottle cap 100 at a time consistent with the dosing schedule, the respective light source 120 of the pill dispensing bottle cap 100 may display a green light and the respective activation system 114 may activate the respective delivery system 112. Turning the respective pill bottle over may cause a pill to to travel through a respective interior funnel 104 into a respective interior pathway 106. Activation of the respective delivery system 112 may cause the pill in the respective interior pathway to be delivered to a respective exterior pathway 110. Gravity may cause the pill to travel through the respective exterior pathway 110, out a respective exterior opening 108, and into a respective hand of the respective trial participant. In traveling through the respective exterior pathway 110 and/or the respective exterior opening 108, the pill may trigger a respective pill sensor 116. Triggering the respective pill sensor 116 may cause a signal to be generated and transferred to the respective client device. The respective client device may record a time the pill was removed from the respective pill bottle. The respective client device may transmit the recorded time the pill was removed to the server associated with the pharmaceutical company. An inventory at the respective client device and/or the server associated with the pharmaceutical company may be updated. The trial participant may remove the respective pill dispensing bottle cap 100 from the respective pill bottle. A respective opening sensor 118 may detect the removal of the respective pill dispensing bottle cap 100 from the respective pill bottle. In response to the detection of the removal of the respective pill dispensing bottle cap 100 from the respective pill bottle, the opening sensor 118 may generate a signal and transfer the signal to the respective client device. The respective client device may generate an alert and transmit the alert to a respective physician. The alert may indicate that the respective trial participant has removed the respective pill dispensing bottle cap 100 from the respective pill bottle.

Referring now to FIG. 6, a block diagram of an example operating environment is shown. The environment may comprise the pill dispensing bottle cap 100, a research platform 604, one or more client devices 608, and a network 610. The pill dispensing bottle cap 100 may comprise a communication device 706 and a sensor 712. The pill dispensing bottle cap 100 may communicate with the research platform 604 and/or the one or more client devices 608 via the network 610. Communication with the pill dispensing bottle cap 100 via the network 610 may be one-way communication from the pill dispensing bottle cap 100, one-way communication to the pill dispensing bottle cap 100, and/or two-way communication. The research platform 604 may communicate with the pill dispensing bottle cap 100 and/or the one or more client devices 608 via the network 610. Communication with the research platform 604 via the network 610 may be one-way communication from the research platform 604, one-way communication to the research platform 604, and/or two-way communication. The one or more client devices 608 may communicate with the pill dispensing bottle cap 100, the research platform 604, and/or one or more other client devices 608 via the network 610. Communication with the one or more client devices 608 via the network 610 may be one-way communication from the one or more client devices 608, one-way communication to the one or more client devices 608, and/or two-way communication.

The sensor 712 may comprise the pill sensor 116 in FIG. 5. The sensor may comprise the opening sensor 118. The sensor 712 may detect an event. The sensor 712 may create a signal indicative of the detected event. The sensor 712 may transmit the signal to the communication device 706.

The communication device 706 may receive one or more sensor signals from the sensor 712 and translate the one or more sensor signals into one or more signals that are suitable for network transmission. The communication device 706 may transmit the signals that are suitable for network transmission across the network 610 to the research platform 604 and/or one or more of the one or more client devices 608. The communication device 706 may receive one or more network signals from the network 610 and translate the one or more network signals into one or more signals that are suitable for one or more modules of the pill dispensing bottle cap 100. The one or more signals that are suitable for one or more modules of the pill dispensing bottle cap 100 may be transmitted to one or more modules of the pill dispensing bottle cap 100. The one or more network signals received by the communication device 706 from the network 610 may originate from the research platform 604 and/or one or more of the one or more client device devices 608.

The research platform 604 may comprise a website. The research platform 604 may comprise a database. The research platform 604 may comprise a researcher facing user interface. A research may input data into the research platform 604 via the researcher facing user interface. The research platform 604 may comprise a model. The model may use the inputted data to model a variety of scenarios and determine and/or update a dosing schedule for one or more trial participants. The research platform 604 may transmit a respective dosing schedule to a respective client device 608 and/or a respective pill dispensing bottle cap 100 via the network 610.

Each of the one or more client devices 608 may comprise one or more computing devices. Each of the one or more client devices 608 may comprise one or more of a smart phone, a tablet, a laptop computing device, a desktop computing device, a wearable computing device, the like, and/or any combination of the foregoing. Each of the one or more client devices 608 may execute a respective application. The respective application may access the research platform 604 via the network 610. The respective application may comprise and/or access to a respective dosing schedule. Each of the one or more client devices 608 may communicate with a respective pill dispensing bottle cap 100 via the network 610. Each of the one or more client devices 608 may transmit a signal indicative of either a time to take a pill or not a time to take a pill to a respective pill dispensing bottle cap 100 via the network 610 based on a dosing schedule and a current time.

The network 610 may comprise a private portion, such as a Wi-Fi router at a premises. The network 610 may comprise a public portion, such as the Internet. The network 610 may comprise physical and/or logical routes. The network 610 may comprise physical and/or wireless connections.

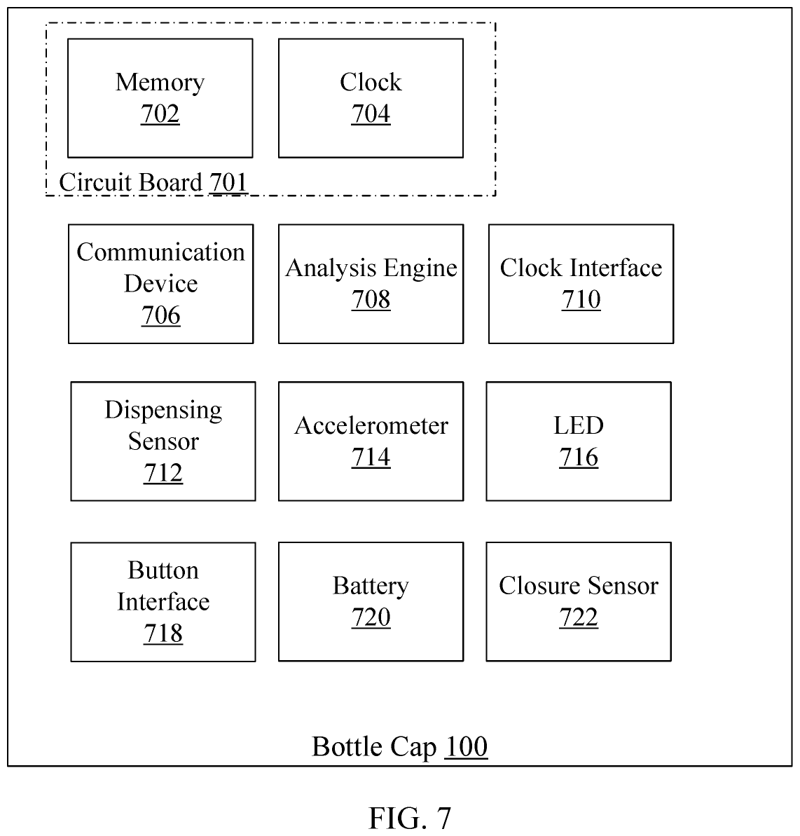

Referring now to FIG. 7, a block diagram of an example pill dispensing bottle cap 100 is shown. The pill dispensing bottle cap 100 may comprise a circuit board 701, a communication device 706, an analysis engine 708, a clock interface 710, a dispensing sensor 712, an accelerometer 714, one or more light-emitting diodes (LEDs) 716, a button interface 718, a battery 720, and a closure sensor 722. The circuit board 701 may comprise a memory 702 and a clock 704. The memory 702 may comprise data, such as a respective dosing schedule. The memory 702 may comprise one or more databases. The clock 704 may track a current time. The respective dosing schedule and the current time may be used to determine if it is time to take a pill or not.

The communication device 706 may receive one or more cap signals from one or more modules and/or elements of the pill dispensing bottle cap 100 and translate the one or more cap signals into one or more signals that are suitable for network transmission. The communication device 706 may transmit the signals that are suitable for network transmission across a network to a network node. The communication device 706 may receive one or more network signals from a network node via the network and translate the one or more network signals into one or more signals that are suitable for one or more modules and/or elements of the pill dispensing bottle cap 100. The one or more signals that are suitable for one or more modules and/or elements of the pill dispensing bottle cap 100 may be transmitted to one or more modules and/or elements of the pill dispensing bottle cap 100.

The analysis engine 708 may comprise one or more computing devices. The analysis engine 708 may comprise one or more software module. The analysis engine 708 may execute in response to engagement of the button interface 718. The analysis engine 708 may execute in response to detection of movement by the accelerometer 714. The analysis engine 708 may retrieve a dosing schedule from the memory 702. The analysis engine 708 may retrieve a current time from the clock 704. The analysis engine 708 may compare the dosing schedule to the current time to determine if it is time to take a pill.

The clock interface 710 may comprise a display. The clock interface 710 may retrieve a current time from the clock 704. The clock interface 710 may display the current time. The clock interface 710 may allow a user to adjust a current time used by the clock 704.

The dispensing sensor 712 may comprise the pill sensor 116 in FIG. 5. The sensor 712 may detect an event. The event may comprise a pill being delivered from an interior pathway to an exterior pathway. The event may comprise a pill has exiting from an exterior opening. The dispensing sensor 712 may create a signal indicative of the detected event. The dispensing sensor 712 may transmit the signal to the communication device 706. The dispensing sensor 712 may transmit the signal to the analysis engine 708. The analysis engine 708 may decrement an inventory of pills in the memory 702 based on the signal from the dispensing sensor 712.

The accelerometer 714 may detect movement of the pill dispensing bottle cap 100. Detection of movement of the pill dispensing bottle cap 100 by the accelerometer 714 may indicate that a user has picked up a pill bottle. An accelerometer on the pill bottle may detect movement of the pill bottle. Movement detected by the accelerometer on the pill bottle may be compared to movement detected by the accelerometer 714 to determine if the pill dispensing bottle cap 100 is moving relative to the pill bottle. If the pill dispensing bottle cap 100 is determined to be moving relative to the pill bottle, then a determination may be made that the pill dispensing bottle cap 100 is being opened.

The one or more LEDs 716 may be controlled by the analysis engine 708. The one or more LEDs 716 may react to a signal provided by the computing device. The one or more LEDs 716 may comprise a setting associated with a time to take a pill. The one or more LEDs 716 may comprise a setting associated with a time not to take a pill. A setting may comprise a position (e.g., “on”, “off”, etc.), a light pattern (e.g., every LED illuminated, every other LED illuminated, every third LED illuminated, etc.), a flashing pattern (e.g., blinking, two fast flashes followed by a long pause, etc.), a color (e.g., red, green, etc.), the like, and/or any combination of the foregoing. For example, the one or more LEDs 716 may display a green color in response to a signal indicative of a time to take a pill. As another example, the one or more LEDs 716 may display a red color in response to a signal indicative of a time to take a pill. The one or more LEDs 716 may illuminate in response to a user engaging the button interface 718. The one or more LEDs 716 may illuminate in response to the accelerometer 714 detecting a movement of the pill dispensing bottle cap 100.

The button interface 718 may comprise a button. Engagement of the button of the button interface 718 may cause the analysis engine 708 to determine if the current time indicates a time to take a pill in accordance with the dosing schedule. When the current time indicates a time to take a pill in accordance with the dosing schedule and a pill bottle is inverted, engagement of the button of the button interface 718 may cause a pill to be dispensed from the pill dispensing bottle top 100. Engagement of the button of the button interface 718 may cause the one or more LEDs 716 to illuminate.

The battery 720 may provide energy and/or power to any element of the pill dispensing bottle cap 100 that may use energy and/or power.

The closure sensor 722 may determine if the pill dispensing bottle cap 100 is separated from the pill bottle. The closure sensor 722 may create a signal in response to determining that the pill dispensing bottle cap 100 is separated from the pill bottle. The closure sensor 722 may transmit the signal to the communication device 706. The communication device 706 may transmit an alert to a physician and/or a pharmaceutical company based on the signal received from the closure sensor 722. The alert may indicate that the pill dispensing bottle cap 100 has been separated from the pill bottle. The closure sensor 722 may transmit the signal to the analysis engine 708. The closure sensor 722 may comprise a computing device in communication with the accelerometer 714 and an accelerometer associated with the pill bottle. The closure sensor 722 may comprise a magnet attracted to an opposing magnet on the pill bottle. The closure sensor 722 may detect when the magnet is not in communication with the opposing magnet. The closure sensor 722 may comprise an optical sensor. The closure sensor 722 may detect when a lighting changes, which indicates that the pill dispensing bottle cap 100 may have separated from the pill bottle to allow more light into the optical sensor. The closure sensor 722 may detect pressure in areas that would typically receive pressure when a user attempts to remove the pill dispensing bottle cap 100 from the pill bottle. The closure sensor 722 may detect audio signals consistent with a user removing the pill dispensing bottle cap 100 from the pill bottle.

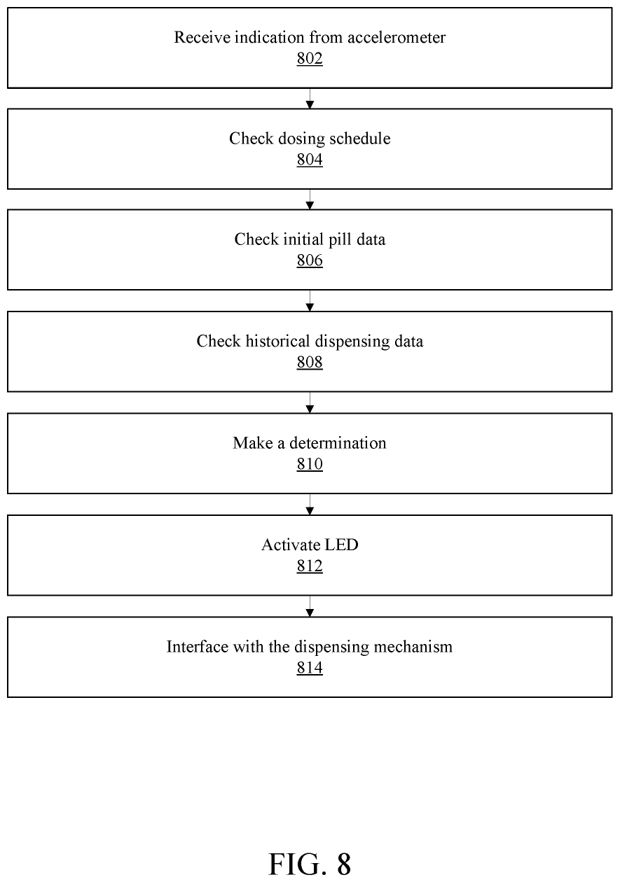

FIG. 8 illustrates a process diagram illustrating an exemplary method in accordance with an embodiment of the invention. The exemplary method may be performed by one or more software modules stored in one or more computing devices. The one or more computing devices may reside in a pill dispensing bottle cap, such as the pill dispensing bottle cap 100 in FIGS. 1-7. The one or more computing devices may be remote from a pill dispensing bottle cap, such as the pill dispensing bottle cap 100.

At step 802, an indication may be received from an accelerometer. The one or more computing devices may receive an indication from the accelerometer. The indication from the accelerometer may indicate a movement of the pill dispensing bottle cap. The indication from the accelerometer may indicate an inversion of the pill dispensing bottle cap. The indication from the accelerometer may be caused by a user manipulating the pill dispensing bottle cap and/or a corresponding pill bottle.

At step 804, a dosing schedule may be checked. The one or more computing devices may check the dosing schedule. Checking the dosing schedule may comprise retrieving a current time from a clock. Checking the dosing schedule may comprise comparing the current time against one or more times in a dosing schedule.

At step 806, initial pill data may be checked. The one or more computing devices may check the initial pill data. The initial pill data may comprise a count of pills in the pill bottle prior to any dispensing. The initial pill data may comprise a count of the pills when the pill dispensing bottle cap was attached to the pill bottle.

At step 808, historical dispensing data may be checked. The one or more computing devices may check the historical dispensing data. The historical dispensing data may comprise a time of each pill dispensed. The historical dispensing data may comprise a count of pills dispensed. The initial pill data and the historical dispensing data may be used to determine a count of pills remaining in the pill bottle. The initial pill data and the historical dispensing data may be used to determine if any pills remain in the pill bottle.

At step 810, a determination may be made. The one or more computing devices may make the determination. The determination may comprise whether a pill should be dispensed or not. Making the determination may comprise using the dosing schedule to determine if taking a pill at the current time is in accordance with the dosing schedule. Making the determination may comprise using the initial pill data and the historical dispensing data to determine if there are any pills in the pill bottle. Making the determination may comprise determining that a pill should be dispensed if taking the pill at the current time is in accordance with the dosing schedule and if there are one or more pills in the pill bottle. Making the determination may comprise determining that a pill should not be dispensed if taking the pill at the current time is not in accordance with the dosing schedule or if there are no pills in the pill bottle. In response to a determination that there are no pills in the pill bottle or that the number of pills in the pill bottle is below a threshold number of pills, a notification may be generated and transmitted to an interested party, such as a physician and/or a pharmaceutical company.

At step 812, one or more light-emitting diodes (LEDs) may be activated. The one or more computing devices may activate the one or more LEDs. If taking the pill at the current time is in accordance with the dosing schedule and if there are one or more pills in the pill bottle, then activating the LEDs may comprise illuminating the LEDs in a first color. The first color may comprise green. If taking the pill at the current time is not in accordance with the dosing schedule, then activating the LEDs may comprise illuminating the LEDs in a second color. The second color may comprise yellow. If there are no pills in the pill bottle, then activating the LEDs may comprise illuminating the LEDs in a third color. The third color may comprise red.

At 814, the one or more computing devices may interface with a dispensing mechanism. The dispensing mechanism may comprise the delivery system 112 and/or the activation system 114 in FIGS. 1-7. If taking the pill at the current time is in accordance with the dosing schedule and if there are one or more pills in the pill bottle, then interfacing with the dispensing mechanism may comprise allowing a pill to be dispensed via the dispensing mechanism. If taking the pill at the current time is in accordance with the dosing schedule and if there are one or more pills in the pill bottle, then interfacing with the dispensing mechanism may comprise causing a pill to be dispensed via the dispensing mechanism. If taking the pill at the current time is not in accordance with the dosing schedule or if there are no pills in the pill bottle, then interfacing with the dispensing mechanism may comprise preventing a pill from being dispensed via the dispensing mechanism.

One embodiment may comprise a cap apparatus for dispensing pills from a pill container (e.g., pill bottle, etc.). The cap apparatus may comprise a closure system for attaching (e.g., coupling, etc.) the cap apparatus to the pill container.

The cap apparatus may comprise an interior funnel disposed on a lower portion of the cap apparatus. The interior funnel may facilitate movement of at least one pill within the pill container towards a central portion of the cap apparatus when the pill container and the cap apparatus are inverted and attached together via the closure system. The interior funnel may be comprised of a broad opening on a side that is furthest from the cap apparatus, and a narrow opening on an opposite side. The interior funnel may direct pills from the broad opening to the narrow opening via the aid of gravitational forces.

The cap apparatus may comprise an interior pathway extending from the interior funnel to the central portion of the cap apparatus. The interior pathway may permit at least one pill to travel from the interior funnel towards the central portion of the cap apparatus. The interior pathway may be large enough to accommodate one pill. A diameter of the interior pathway may be adjustable. The diameter of the interior pathway may be adjustable by extending or retracting an element that partially occludes a portion of the interior pathway.

The cap apparatus may comprise an exterior opening disposed on an upper portion of the cap apparatus. The exterior opening may permit a pill to travel out of the pill container.

The cap apparatus may comprise an exterior pathway extending from the exterior opening to the central portion of the cap apparatus. A diameter of the exterior pathway may be adjustable. The diameter of the exterior pathway may be adjustable by extending or retracting an element that partially occludes a portion of the exterior pathway.

The cap apparatus may comprise a delivery system for delivering a pill from the interior pathway to the exterior pathway. The delivery system may cause the interior pathway to move, thereby aligning the interior pathway to the exterior pathway and enabling a pill to move from the interior pathway to the exterior pathway. The delivery system may cause the exterior pathway to move, thereby aligning the exterior pathway to the interior pathway and enabling a pill to move from the interior pathway to the exterior pathway. The delivery system may cause a connection portion to move, thereby connecting the interior pathway to the exterior pathway, and enabling a pill to move from the interior pathway to the exterior pathway via the connection portion.

The cap apparatus may comprise an activation system for activating the delivery system thereby causing the delivery system to deliver a pill from the interior pathway to the exterior pathway. The activation system may be activated when a user performs an action. The interior pathway and the exterior pathway may not be connected unless the delivery system is activated. The activation system may comprise a button that may be pressed by a user.

The cap apparatus may comprise a sensor system for determining when a pill has been delivered from the interior pathway to the exterior pathway.

The cap apparatus may comprise a second sensor for detecting when a pill has exited from the exterior opening.

The cap apparatus may comprise an electronic detection system for detecting when a user is handling the pill container that is attached to the cap apparatus. The electronic detection system may comprise an accelerometer.

The cap apparatus may comprise at least one light emission source and at least one electronic detection system for detecting when a user is handling the pill container that is attached to the cap apparatus.

The cap apparatus may comprise an electronics system including at least a memory, and a clock.

The cap apparatus may comprise an electronics system comprising a light emission source, an accelerometer, a memory, and a clock, and an electronic communications device for wirelessly communicating with one or more other electronic devices. The light emission source may emit light when the accelerometer detects movement. The memory may store a dosing schedule that may be downloaded via the electronic communications device. The light emission source may emit a green light when the accelerometer detects movement, and if a processor determines that it is time for a user to take a pill based on the stored dosing schedule, a time according to the clock, and data stored in the memory regarding previous times when a pill exited the cap apparatus.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

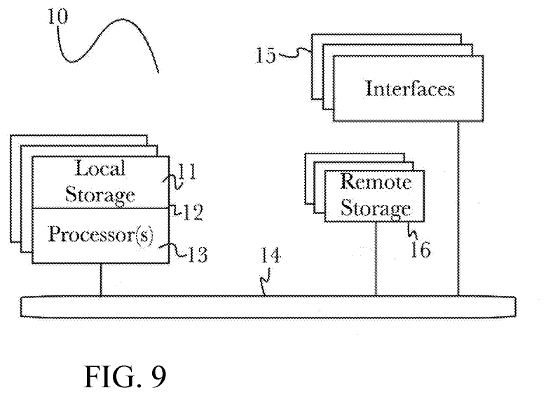

Referring now to FIG. 9, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 9 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

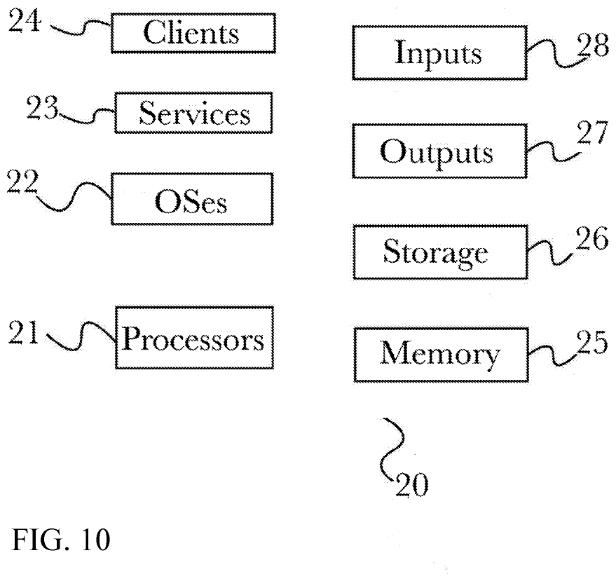

In some embodiments, systems may be implemented on a standalone computing system. Referring now to FIG. 10, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 9). Examples of storage devices 26 include flash memory, magnetic hard drive, CD-ROM, and/or the like.

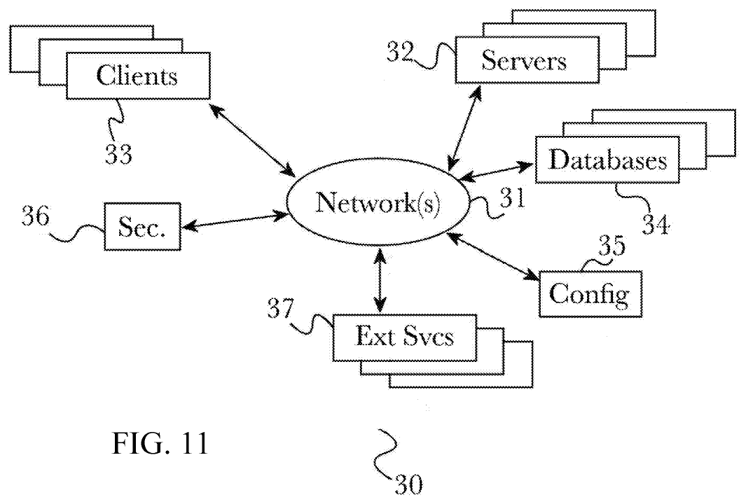

In some embodiments, systems may be implemented on a distributed computing network, such as one having any number of clients and/or servers. Referring now to FIG. 11, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 10. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

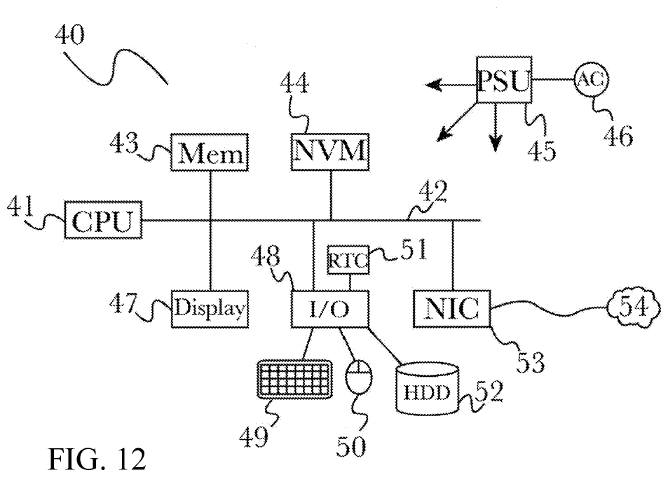

FIG. 12 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

1. A cap apparatus for dispensing pills from a pill container, the apparatus comprising:
a closure system for attaching the cap apparatus to the pill container, the pill container having a longitudinal centerline;
an interior funnel disposed on a lower portion of the cap apparatus, wherein the interior funnel facilitates movement of at least one pill within the pill container towards a central portion of the cap apparatus when the pill container and the cap apparatus are inverted and attached together via the closure system;
an interior pathway extending from the interior funnel to the central portion of the cap apparatus, the interior pathway permitting a pill having a pill length and a pill width and aligned along the pill length substantially parallel to the longitudinal centerline of the pill container, the interior pathway sized to hold the pill in its aligned position within the pathway as the pill travel from the interior funnel towards the central portion of the cap apparatus;
an exterior opening disposed on an upper portion of the cap apparatus, wherein the exterior opening is aligned substantially parallel to the longitudinal centerline of the pill container and permits a pill to travel out of the pill container;
an exterior pathway extending from the exterior opening to the central portion of the cap apparatus;
a delivery system for delivering a pill from the interior pathway to the exterior pathway;
an activation system for activating the delivery system thereby causing the delivery system to deliver the pill from the interior pathway to the exterior pathway, the activation system being activated when a user performs an action, wherein the interior pathway and the exterior pathway are not connected unless the delivery system is activated, wherein activation of the delivery system causes at least one of the interior pathway and the exterior pathway to move laterally relative to a plane while the pill remains aligned substantially parallel along the longitudinal centerline of the pill container in order to connect the interior pathway to the exterior pathway, and wherein the plane is parallel to an upper surface of the cap apparatus; and
a sensor system for determining when the pill has been delivered from the interior pathway to the exterior pathway.

2. The apparatus of claim 1, wherein the interior funnel is comprised of a broad opening on a side that is furthest from the cap apparatus, and a narrow opening on an opposite side, wherein the interior funnel directs pills from the broad opening to the narrow opening via the aid of gravitational forces.

3. The apparatus of claim 1, wherein the interior pathway is large enough to accommodate one pill.

4. The apparatus of claim 1, wherein a diameter of the interior pathway is adjustable.

5. The apparatus of claim 4, wherein the diameter of the interior pathway is adjustable by extending or retracting an element that partially occludes a portion of the interior pathway.

6. The apparatus of claim 1, wherein a diameter of the exterior pathway is adjustable.

7. The apparatus of claim 6, wherein the diameter of the exterior pathway is adjustable by extending or retracting an element that partially occludes a portion of the exterior pathway.

8. The apparatus of claim 1, wherein the delivery system causes the interior pathway to move, thereby aligning the interior pathway to the exterior pathway and enabling a pill to move from the interior pathway to the exterior pathway.

9. The apparatus of claim 1, wherein the delivery system causes the exterior pathway to move, thereby aligning the exterior pathway to the interior pathway and enabling a pill to move from the interior pathway to the exterior pathway.

10. The apparatus of claim 1, wherein the delivery system causes a connection portion to move, thereby connecting the interior pathway to the exterior pathway, and enabling a pill to move from the interior pathway to the exterior pathway via the connection portion.

11. The apparatus of claim 1, wherein the activation system comprises a button that may be pressed by a user.

12. (canceled)

13. (canceled)

14. The apparatus of claim 15, wherein the electronic detection system comprises an accelerometer.

15. The apparatus of claim 1, further comprising at least one light emission source and at least one electronic detection system for detecting when a user is handling the pill container that is attached to the cap apparatus.

16. The apparatus of claim 1, further comprising an electronics system including at least a memory, and a clock.

17. The apparatus of claim 1, further comprising an electronics system comprising a light emission source, an accelerometer, a memory, and a clock, and an electronic communications device for wirelessly communicating with one or more other electronic devices.

18. The apparatus of claim 17, wherein the light emission source emits light when the accelerometer detects movement.

19. The apparatus of claim 17, wherein the memory stores a dosing schedule that is downloaded via the electronic communications device.

20. The apparatus of claim 19, wherein the light emission source emits a green light when the accelerometer detects movement, and if a processor determines that it is time for a user to take a pill based on the stored dosing schedule, a time according to the clock, and data stored in the memory regarding previous times when a pill exited the cap apparatus.
